(19) United States
(12) Patent Application Publication
(10) Pub. No.: US 2022/0352607 A1
(43) Pub. Date: Nov. 3, 2022

(54) DYNAMIC PORTABLE POWER PACK APPARATUS

(71) Applicant: Mazen Moein Mokhtar, Irving, TX (US)

(72) Inventor: Mazen Moein Mokhtar, Irving, TX (US)

(21) Appl. No.: 17/244,969

(22) Filed: Apr. 30, 2021

(51) Int. Cl. H01M 50/543; H01M 50/247; H01M 50/204

(52) U.S. Cl. CPC H01M 50/543; H01M 50/247; H01M 50/204; H01M 2220/30

(57) ABSTRACT

Disclosed below is a dynamic portable power pack apparatus facilitating connection to provide power for almost all devices. The apparatus comprises of a battery pack and a battery management system. Additionally, the apparatus consists of a universal socket which facilitates connections for all types of plugs. Further, the apparatus comprises multiple input pins that are designed for connecting various types of input pins.

### TECHNICAL FIELD

Various embodiments are directed to apparatus and systems designed electrical engineering, specifically batteries and power management. More particularly, the present disclosure relates to battery packs and other apparatus configured to be of universal use and support multiple devices.

### BACKGROUND

With the advancements in technology, humans have invented various devices. These devices operate at different voltage and many devices has its own specific means for connection. Additionally, in different countries, the plug sockets are of different sizes. So, a device manufactured in one country may not work properly in another country because of the difference is voltage/wattage, different sizes of plugs and pins, etc.

Traditionally, this problem has been solved by using various adaptors to facilitate connections. Additionally, other devices such as a voltage stabilizer etc have to be used to regulated and control the voltage and wattage.

However, it is impossible for any person to always carry all the possible adaptors and connectors to make all their devices are operable. Additionally, these connectors typically work with regular electric supply and not from battery packs and power banks. Thereby, they are not portable as well.

In light of the above-mentioned shortcomings associated with existing battery systems and power supply system, it is highly desirable to have an apparatus which could provide a portable power supply which is universal in nature.

### SUMMARY

Embodiments of the present disclosure present technological improvements as solutions to one or more of the above-mentioned technical problems recognized by the inventor in conventional systems.

The present invention discloses an apparatus, system and method for a dynamic portable power pack. Disclosed below is a dynamic portable power pack apparatus that facilitates connections to all possible devices by having multiple input pins, universal plugs, and a battery management system to ensure that the batteries are operated within the designated operating conditions.

In a primary aspect of the present invention, it discloses an apparatus comprising one or more battery packs communicable coupled with at least one battery management system, one or more universal sockets to facilitate connection for one or more plugs, one or more boosters connected to one or more universal serial bus input pins to facilitate connection for one or more USB inputs and at least one wireless energy controller connected to a wireless charging coil to facilitate wireless charging.

In various other aspect of the same invention, the universal socket facilitates connection for all types of plugs, including but not limited to EU Plugs, US Plugs and AU Plugs.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

While the systems and methods are illustrated by use of batteries and their embodiments and applications, they are equally applicable to virtually any power supply apparatus, facilitating connection to any device, without limiting the scope of the invention.

### BRIEF DESCRIPTION OF DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of the dynamic portable power pack apparatus, in accordance with an embodiment of the present disclosure;

In the accompanying drawings, an underlined number is employed to represent an material over which the underlined number is positioned or an material to which the underlined number is adjacent. A non-underlined number relates to an material identified by a line linking the non-underlined number to the material. When a number is non-underlined and accompanied by an associated arrow, the nonunderlined number is used to identify a general material at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses an apparatus, system and method for dynamic portable power pack that facilitates connections to a plurality of devices, by having at least one universal socket, a plurality of input pins, and a battery management system to ensure that the batteries are operated within the designated operating conditions.

In a primary aspect of the present invention, it discloses an apparatus comprising one or more battery packs communicable coupled with at least one battery management system, one or more universal sockets to facilitate connection for one or more plugs, one or more boosters connected to one or more universal serial bus input pins to facilitate connection for one or more USB inputs and at least one wireless energy controller connected to a wireless charging coil to facilitate wireless charging.

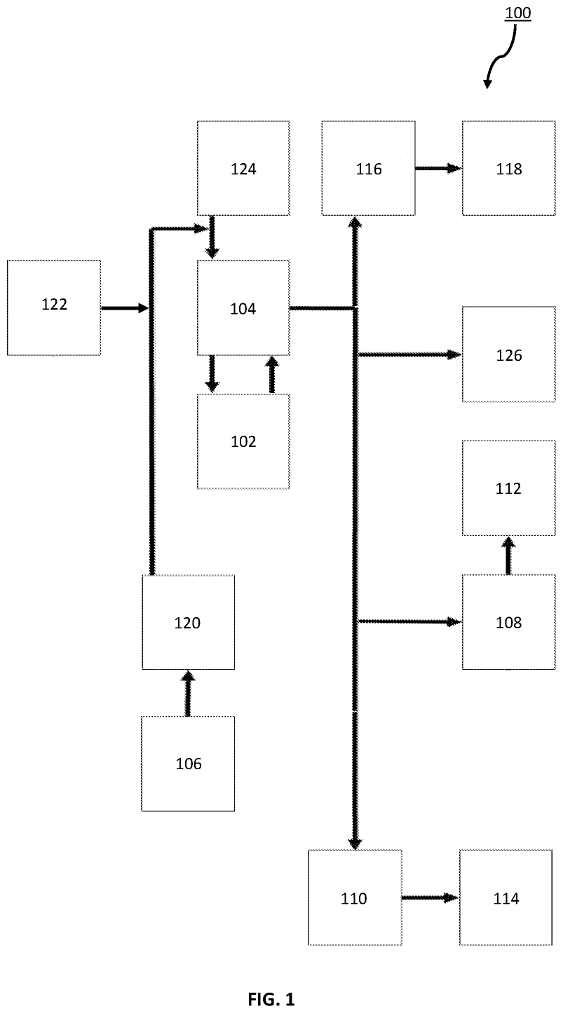

FIG. 1 is a schematic illustration of an exemplary embodiment of the dynamic portable power pack 100, wherein the apparatus comprises a battery packs 102 communicable coupled with at least one battery management system 104. The battery pack 102 comprises one or more batteries. The said one or more batteries are rechargeable batteries. However, in other embodiments of the same invention, the battery pack 102 is made or one or more non rechargeable batteries. Further, the apparatus comprises of a universal socket 106. The apparatus 100 further comprises at least a Type A booster 108 and a Type C booster 110 connected to a universal serial bus type A input pin 112 and a universal serial bus type C input pin 114 respectively. Furthermore, the apparatus comprises a wireless energy controller 116 connected to a wireless charging coil 118 to facilitate wireless charging.

The apparatus 100 further comprises a USB 3.0 pin 122 to facilitate connection of USB flash drive and a micro USB input pin 124 to facilitate connection of micro SD cards and other micro USB devices. The apparatus 100 further comprises a step down convertor 120 connected to the universal socket 106. Many devices such as a bluetooth speaker 126 is also connected to the apparatus 100.

In the primary embodiment of the same invention, the at least one battery management system of the apparatus is an any electronic apparatus that manages the one or more battery packs. It facilitates connections to the one or more battery packs and the charging and discharging of the one or more battery packs. All the devices are connected in the apparatus to the one or more battery packs via the battery management system. The said battery management system is configured to protect the one or more battery packs from operating outside their safe operating conditions. Further, it is configured to monitor the state of the one or more battery packs. Additionally, beneficially the battery management system facilitates capture of usage data, tracking and analysis of the usage data. This can be used to optimize the lifetime of the batteries and make any changes, if needed.

In various embodiments of the same invention, the apparatus comprises one or more universal sockets. The one or more universal sockets are used so as to facilitate connections to various types of plugs. Without limiting the scope of the invention, some of the plugs that the one or more universal sockets facilitates connections are a EU Plug, an AU Plug and a US Plug. The one or more universal sockets are designed in such a manner so as to facilitate connection to any type of plug.

In an alternate embodiment of the same invention, within the apparatus 100, the one or more universal sockets are connected to at least one step down convertor to regulate an input voltage received. Typically, the at least one step down convertor are electronic/electric transformers wherein output voltage is lower than its input voltage. This also ensures the apparatus is working in safe working range and the one or more battery packs and the one or more devices connected to the one or more battery packs are safe.

In some other embodiments of the present invention, the apparatus comprises the one or more boosters connected to the one or more universal serial bus input pins. For illustration purposes only, without limiting the scope of the invention, the one or more boosters is a USB Type A booster and a USB Type C booster, which facilitate connections for USB Type A input and USB Type C input respectively. Additionally, optionally, the one or more boosters may be any type of booster facilitating connection to various types of USB inputs. Alternatively, optionally, the apparatus facilitates connection for one or more devices via one or more micro USB input pins.

In another embodiment of the present disclosure, the apparatus is connected to one or more memory devices via one or more input pins communicable coupled via the at least one battery management apparatus. The battery usage date and other metrics being tracked by the battery management apparatus is stored in the one or more memory devices.

Without limiting the scope of the present invention, persons skilled in the art must appreciate that the apparatus is capable of facilitating connection for plurality of devices via plurality of input pins. Any type of devices can be connected to the dynamic portable power pack apparatus.

One or more components of the invention are described as unit for the understanding of the specification. For example, a unit may include self-contained component in a hardware circuit comprising of logical gate, semiconductor device, integrated circuits or any other discrete component. The unit may also be a part of any software programme executed by any hardware entity for example processor. The implementation of unit may be as a combination of multiple units, multiple devices and multiple hardware entities.

Additional or less units can be included without deviating from the novel art of this disclosure. In addition, each unit can include any number and combination of sub-units, and systems, implemented with any combination of hardware and/or software units.

The Battery Management System Method may be an electronic circuit comprising one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random-access memory) and writes (stores) instructions and data to the memory.

In another embodiment of the same invention, the apparatus disclosed herein has multiple levels of security integrated, such as one or more fuses, automatic off feature in case of voltage surges. This ensures that the one or more devices connected to the dynamic portable power pack apparatus is not harmed.

In the primary embodiment of the present disclosure, the dynamic portable power pack apparatus comprises one or more battery packs. Each of the battery packs comprises one or more rechargeable batteries. The battery management system manages the charging and discharging of the batteries. Optionally, the apparatus may comprise of non-rechargeable batteries as well.

Various embodiments of the present invention may also be implemented in other verticals as well. The system works well for any number of devices and batteries and for any number of users.

It shall be further appreciated by the person skilled in the art that the terms “first”, “second” and the like herein do not denote any specific role or order or importance, but rather are used to distinguish one party from another.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for materials, components or elements not explicitly described also to be present. Reference to the singular is also to be construed to relate to the plural.

Although an exemplary embodiment of at least one apparatus has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, all or part of the functionality performed by the individual modules, may be performed by one or more of these modules. Further, the functionality described herein may be performed at various times and in relation to various events, internal or external to the modules or components.

One skilled in the art will appreciate that an “apparatus” could be embodied as a combination of one or more hardware components, electronic circuits, a processor, or any other suitable device, or combination of devices. Presenting the above-described functions as being performed by an “apparatus” is not intended to limit the scope of the present application in any way, but is intended to provide one example of many embodiments. Indeed, apparatus disclosed herein may be implemented in localized and distributed forms consistent with electrical and electronics technology.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein can be implemented in suitable computer-executable instructions. It will be appreciated that features of the present disclosure are susceptible to being combined in various combinations and additional features may be introduced without departing from the scope of the present disclosure.

1. A dynamic portable power pack apparatus, the apparatus comprising:
one or more battery packs communicable coupled with at least one battery management system;
one or more universal sockets to facilitate connection for one or more plugs;
one or more boosters connected to one or more universal serial bus input pins to facilitate connection for one or more USB inputs; and
at least one wireless energy controller connected to a wireless charging coil to facilitate wireless charging.

2. The apparatus of claim 1 wherein the at least one battery management system is an any electronic apparatus that manages the one or more battery packs, configured to at least:
protect the one or more battery packs from operating outside their safe operating conditions;
monitor the state of the one or more battery packs;
facilitate tracking and analysis of usage data; and
facilitate connections to the one or more battery packs.

3. The apparatus of claim 1 wherein the one or more universal sockets facilitates connections to at least an EU Plug, an AU Plug and a US Plug.

4. The apparatus of claim 1 wherein the one or more universal sockets are connected to at least one step down convertor to regulate an input voltage received.

5. The apparatus of claim 1 wherein the one or more universal sockets, one or more boosters, and the at least one wireless energy controller are connected to the one or more battery packs via the at least one battery management system.

6. The Apparatus of claim 1 wherein the one or more boosters connected to the one or more universal serial bus input pins is a USB Type A booster to facilitate connection for USB Type A input.

7. The Apparatus of claim 1 wherein the one or more boosters connected to the one or more universal serial bus input pins is a USB Type C booster to facilitate connection for USB Type C input.

8. The apparatus of claim 1 wherein the apparatus facilitates connection for one or more devices via one or more micro USB input pins.

9. The apparatus of claim 1 wherein the apparatus facilitates connection for one or more memory devices via one or more input pins communicable coupled via the at least one battery management apparatus.

10. The apparatus of claim 1 wherein the apparatus facilitates connection for plurality of devices via plurality of input pins.
